(19) United States
(12) Patent Application Publication
(10) Pub. No.: US 2026/0358735 A1
(43) Pub. Date: Nov. 12, 2026

(54) DEVELOPING DEVICE AND IMAGE FORMING APPARATUS PROVIDED WITH THE SAME

(71) Applicant: KYOCERA Document Solutions Inc., Osaka (JP)

(72) Inventors: Katen KO, Osaka (JP); Tomohiro TAMAKI, Osaka (JP); Takeru NAGAMOTO, Osaka (JP)

(73) Assignee: KYOCERA Document Solutions Inc., Osaka (JP)

(21) Appl. No.: 19/667,503

(22) Filed: May 4, 2026

(30) Foreign Application Priority Data
May 12, 2025 (JP) 2025-079942

(51) Int. Cl. G03G 15/08

(52) U.S. Cl. CPC G03G 15/0818; G03G 15/0812; G03G 15/0891; G03G 2215/085

(57) ABSTRACT

A developing device includes a developing container including a first conveyance chamber and a second conveyance chamber, a first stirring conveyance member, a second stirring conveyance member, a developer carrying member, and a regulation blade. The developer carrying member includes a magnetic member having a regulation pole, a main pole, a release pole, and a pump-up pole. The developing container includes a division wall extending downward from below the second conveyance chamber. Where X [°] is an angle formed between two straight lines, one of which passes through a rotation center of the developer carrying member and a release start position at which the release pole has a magnetic force of not more than 5 [mT] and the other of which passes through the rotation center and an endpoint position of the division wall at an end thereof near the second conveyance chamber, −15≤X≤10 is satisfied.

### INCORPORATION BY REFERENCE

This application is based upon and claims the benefit of priority from the corresponding Japanese Patent Application No. 2025-079942 (filed on May 12, 2025), the entire contents of which are hereby incorporated by reference.

### BACKGROUND

The present disclosure relates to a developing device and an image forming apparatus provided with the same, and relates particularly to a developing device including a first conveyance chamber and a second conveyance chamber and an image forming apparatus provided with the same. In the developing device, the first conveyance chamber includes inside a stirring conveyance member for stirring and conveying a developer, and the second conveyance chamber is arranged above the first conveyance chamber.

In an image forming apparatus, by a developing device, a latent image formed on an image carrier formed of a photosensitive member or the like is developed and visualized into a toner image. A known type of developing device as described above includes a developing container for containing a developer, first and second stirring conveyance members for stirring and conveying the developer, and a developing roller (developer carrying member) that carries the developer supplied from the second stirring conveyance member. The first stirring conveyance member conveys the developer to one side in an axis direction of the developing roller, and the second stirring conveyance member supplies the developer to the developing roller while conveying the developer to the other side (a side opposite to the one side).

Meanwhile, recent years have seen a growing demand for size reduction of image forming apparatuses, and particularly in color image forming apparatuses each including a plurality of developing devices arranged therein, there is a demand for size reduction of the developing devices. To meet this demand, there is a known type of developing device including a first conveyance chamber and a second conveyance chamber, in which the first conveyance chamber includes inside a first stirring conveyance member, and the second conveyance chamber is arranged above the first conveyance chamber and includes inside a second stirring conveyance member. In this type of developing device, the first conveyance chamber and the second conveyance chamber are arranged one above the other, and thus compared with a configuration in which the first conveyance chamber and the second conveyance chamber are horizontally arranged side by side, the developing device can be reduced in size in a horizontal direction. It is, therefore, possible to reduce a space required for arranging the developing device and thus to achieve size reduction of an image forming apparatus.

### SUMMARY

A developing device according to one aspect of the present disclosure includes a developing container, a first stirring conveyance member, a second stirring conveyance member, a developer carrying member, and a regulation blade, and develops an electrostatic latent image formed on an image carrier into a toner image. The developing container includes a first conveyance chamber and a second conveyance chamber arranged adjacently to the first conveyance chamber via a partition, and contains a developer including a carrier and toner. The first stirring conveyance member is rotatably supported in the first conveyance chamber and conveys, while stirring, the developer in the first conveyance chamber in a first direction. The second stirring conveyance member is rotatably supported in the second conveyance chamber so as to be parallel to the first stirring conveyance member and conveys, while stirring, the developer in the second conveyance chamber in a second direction opposite to the first direction. The developer carrying member is rotatably supported to the developing container and carries, on a surface thereof, the developer in the second conveyance chamber. The regulation blade is arranged to be opposed to the developer carrying member and regulates a layer thickness of the developer on the developer carrying member. The developing device performs, in the second conveyance chamber, supply of the developer to and collection of the developer from the developer carrying member. The developer carrying member includes a rotatable cylindrical developing sleeve and a magnetic member non-rotatably secured inside the developing sleeve and having, along a rotation direction of the developing sleeve, a plurality of magnetic poles including a regulation pole opposed to the regulation blade, a main pole opposed to the image carrier, a release pole for releasing the developer carried on the developer carrying member, and a pump-up pole for pumping up the developer onto the developer carrying member. The developing container includes a division wall extending downward from below the second conveyance chamber so as to be opposed to the developer carrying member. Where X [°] is an angle formed between a straight line passing through a rotation center of the developer carrying member and a release start position at which the release pole has a magnetic force of not more than 5 [mT] and a straight line passing through the rotation center of the developer carrying member and an endpoint position of the division wall at an end thereof near the second conveyance chamber, and X has a positive value when the endpoint position lies downstream of the release start position in the rotation direction of the developing sleeve and has a negative value when the endpoint position lies upstream thereof, a formula (1) below is satisfied:

−15≤X≤10 (1).

### BRIEF DESCRIPTION OF THE DRAWINGS

FIG. 1 is a schematic sectional view showing an overall configuration of an image forming apparatus provided with developing devices of the present disclosure.

FIG. 2 is a sectional side view showing a structure of a stirring portion of a developing device according to one embodiment of the present disclosure.

FIG. 3 is a vertical sectional view of the developing device of the embodiment cut along a direction orthogonal to a longitudinal direction thereof.

FIG. 4 is an enlarged sectional view of and around a second conveyance chamber shown in FIG. 3, illustrating a magnetic force distribution and a developer release region of a magnetic member of a developing roller.

FIG. 5 is an enlarged sectional view of and around the second conveyance chamber indicative of a relationship between a release start position and an endpoint position of a division wall, illustrating a case where the endpoint position lies downstream of the release start position in a rotation direction of the developing roller.

FIG. 6 is an enlarged sectional view of and around the second conveyance chamber indicative of a relationship between the release start position and the endpoint position of the division wall, illustrating a case where the endpoint position lies upstream of the release start position in the rotation direction of the developing roller.

FIG. 7 is a graph showing variations in developer leakage amount and in image density difference in a case where an angle [°] between the release start position and the endpoint position of the division wall is made to vary.

FIG. 8 is a partially enlarged view of and around the division wall shown in FIG. 4.

### DETAILED DESCRIPTION

### 1. Overall Configuration of Image Forming Apparatus

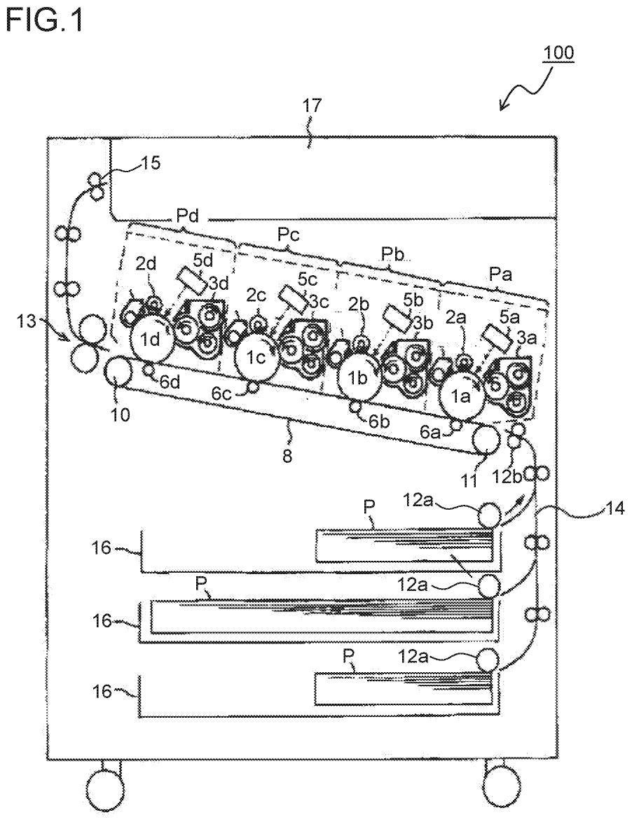

With reference to the appended drawings, the following describes an embodiment of the present disclosure. FIG. 1 is a schematic sectional view of an image forming apparatus 100 provided with developing devices 3a to 3d of the present disclosure, which herein is a tandem-type color printer. In a main body of the image forming apparatus 100, four image forming portions Pa, Pb, Pc, and Pd are disposed in this order from upstream in a conveyance direction (a right side in FIG. 1). The image forming portions Pa to Pd are provided so as to correspond to images of four different colors (yellow, cyan, magenta, and black) and sequentially form the images of yellow, cyan, magenta, and black, respectively, through steps of charging, exposure, development, and transfer.

In the image forming portions Pa to Pd, there are respectively disposed photosensitive drums 1a, 1b, 1c, and 1d that carry visible images (toner images) of the different colors. Furthermore, a conveyance belt 8 that rotates clockwise in FIG. 1 is provided adjacently to the image forming portions Pa to Pd.

Upon an input of image data from a host apparatus such as a personal computer, first, charging devices 2a to 2d uniformly charge surfaces of the photosensitive drums 1a to 1d, respectively. Then, exposure devices 5 apply light to the surfaces of the photosensitive drums 1a to 1d in accordance with the image data so that electrostatic latent images corresponding to the image data are formed on the photosensitive drums 1a to 1d. Each of the developing devices 3a to 3d is filled with a prescribed amount of a two-component developer (hereinafter, also referred to simply as a developer) containing toner of a corresponding one of the different colors of yellow, cyan, magenta, and black replenished respectively from toner containers (not shown) and a magnetic carrier. The toner in the developer is supplied onto the photosensitive drums 1a to 1d by the developing devices 3a to 3d, respectively, and electrostatically adheres thereto. Thus, there are formed toner images corresponding to the electrostatic latent images formed by exposure to light from the exposure devices 5.

Further, transfer rollers 6a to 6d apply an electric field of a prescribed transfer voltage between themselves and the photosensitive drums 1a to 1d, respectively, and thus the toner images of yellow, cyan, magenta, and black respectively on the photosensitive drums 1a to 1d are transferred onto a transfer sheet P carried on the conveyance belt 8. Residual toner or the like remaining on the surfaces of the photosensitive drums 1a to 1d after primary transfer is removed by cleaning devices 7a to 7d, respectively.

A transfer sheet P onto which toner images are to be transferred is housed any of sheet cassettes 16 arranged in a lower part of the image forming apparatus 100. The transfer sheet P is conveyed at a prescribed timing to the conveyance belt 8 via a paper feed roller 12a and a registration roller pair 12b. The transfer sheet P onto which the toner images have been transferred is conveyed to a fixing portion 13.

The transfer sheet P conveyed to the fixing portion 13 is heated and pressed as passes through a nip between a fixing belt and a pressing roller so that the toner images are fixed to a surface of the transfer sheet P, and thus a prescribed full-color image is formed thereon. The transfer sheet P on which the full-color image has been formed is directly (or after having been directed by a branch portion 14 into a reverse conveyance path 18 and thus subjected to image formation on its other side as well) discharged onto a discharge tray 17 by a discharge roller pair 15.

### 2. Configuration of Developing Device

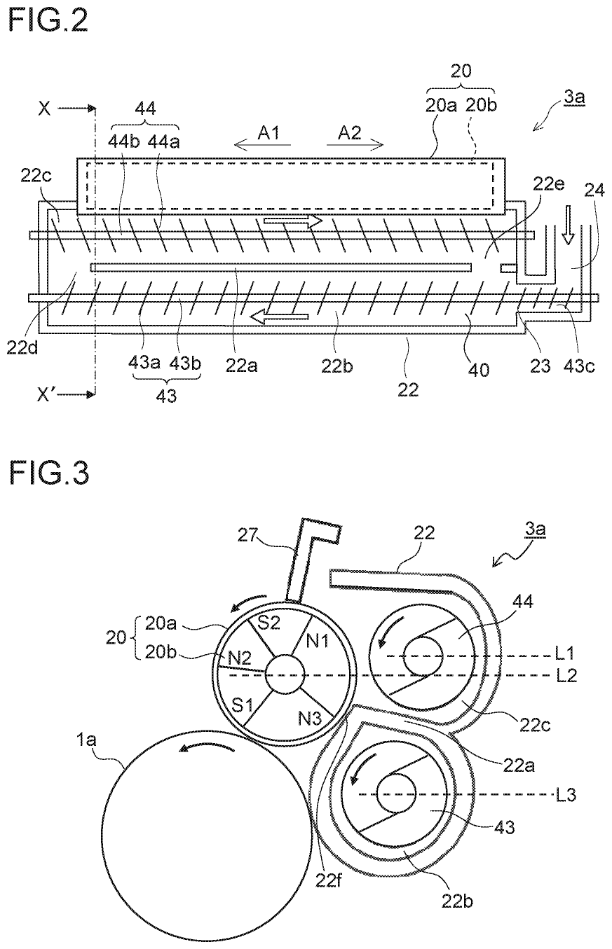

FIG. 2 is a vertical sectional view showing a structure of a stirring portion a developing device 3a according to one embodiment of the present disclosure mounted in the image forming apparatus 100. While a description is given herein of the developing device 3a arranged in the image forming portion Pa shown in FIG. 1, developing devices 3b to 3d arranged in the image forming portions Pb to Pd, respectively, are also basically similar in configuration to the developing device 3a and thus are omitted from the description. Furthermore, note that, in FIG. 2, for the sake of convenience of explanation, a developing roller 20 is depicted to be positionally shifted to an upper side relative to a second conveyance chamber 22c.

As shown in FIG. 2, the developing device 3a includes the developing roller (a developer carrying member) 20, a first spiral (first stirring conveyance member) 43, a second spiral (second stirring conveyance member) 44, and a developing container 22. The developing container 22 constitutes an outer contour of the developing device 3a, and formed therein are a partition 22a, a first conveyance chamber 22b, the second conveyance chamber 22c, a first communication portion 22d, and a second communication portion 22e. A two-component developer composed of a magnetic carrier and toner is contained in the first conveyance chamber 22b and the second conveyance chamber 22c. Furthermore, the developing container 22 rotatably holds the first spiral 43, the second spiral 44, and the developing roller 20.

The partition 22a extends along a longitudinal direction of the developing container 22 so as to divide, from each other, the first conveyance chamber 22b and the second conveyance chamber 22c arranged one above the other. The first communication portion 22d and the second communication portion 22e are formed at one and the other sides of the partition 22a in a longitudinal direction thereof (downstream in an A1 direction and downstream in an A2 direction), respectively. The first communication portion 22d provides communication between respective downstream ends of the first conveyance chamber 22b and the second conveyance chamber 22c in the A1 direction (a first direction). The second communication portion 22e provides communication between respective downstream ends of the first conveyance chamber 22b and the second conveyance chamber 22c in the A2 direction (a second direction). Further, the developer circulates through the first conveyance chamber 22b, the first communication portion 22d, the second conveyance chamber 22c, and the second communication portion 22e.

The first spiral 43 is disposed in the first conveyance chamber 22b. The first spiral 43 includes a rotary shaft 43b rotatably supported to the developing container 22 and a first spiral blade 43a provided integrally with the rotary shaft 43b and spirally formed at a constant pitch along an axis direction of the rotary shaft 43b. By an unshown drive mechanism, the first spiral 43 is driven to rotate in a prescribed direction (counterclockwise in FIG. 3). When rotated in the prescribed direction, the first spiral blade 43a conveys, while stirring, the developer in the first conveyance chamber 22b in the A1 direction (to one side of the developing roller 20 in an axis direction thereof).

Furthermore, a toner replenishment port 23 for replenishing the toner into the developing container 22 is provided in an end surface of the first conveyance chamber 22b in the A2 direction. A toner replenishment path 24 continuously connected to the toner container (not shown) is connected to the toner replenishment port 23. The rotary shaft 43b is arranged to pass through the toner replenishment port 23 into the toner replenishment path 24. A replenishment blade 43c is formed integrally with a part of the rotary shaft 43b arranged in the toner replenishment path 24 and spirally formed at a constant pitch along the axis direction of the rotary shaft 43b. The replenishment blade 43c is formed of a spiral blade having the same spiral direction (phase) as that of the first spiral blade 43a. The replenishment blade 43c is formed to be smaller in pitch and diameter than the first spiral blade 43a.

The second spiral 44 is disposed in the second conveyance chamber 22c. The second spiral 44 includes a rotary shaft 44b rotatably supported to the developing container 22 so as to be parallel to the rotary shaft 43b and a second spiral blade 44a provided integrally with the rotary shaft 44b and spirally formed to have a spiral direction (phase) opposite to that of the first spiral blade 43a. By an unshown drive mechanism, the second spiral 44 is driven to rotate in a prescribed direction (counterclockwise in FIG. 3). When rotated in the same direction as the rotation direction of the first spiral blade 43a, the second spiral blade 44a supplies, to the developing roller 20, while stirring and conveying, the developer in the second conveyance chamber 22c in the A2 direction (in a direction opposite to the A1 direction).

The first spiral 43 and the second spiral 44 stir the developer so that the toner in the developer is charged to a prescribed level. This causes the toner to be held by the carrier. When the first spiral 43 and the second spiral 44 rotate, the developer is conveyed through one (the first communication portion 22d) of the communication portions provided at the partition 22a to the second spiral 44 and through the other (the second communication portion 22e) of the communication portions to the first spiral 43, thus circulating between the first conveyance chamber 22b and the second conveyance chamber 22c. Further, the developer is supplied from the second spiral 44 to the developing roller 20, and thus a magnetic brush is formed on the developing roller 20.

The developing roller 20 includes a developing sleeve 20a rotatably supported to the developing container 22 and a magnetic member 20b secured to a stationary shaft (not shown) in the developing sleeve 20a and having a plurality of magnetic poles. By an unshown drive mechanism, the developing sleeve 20a is driven to rotate in an arrow direction (counterclockwise) in FIG. 3. Furthermore, a developing voltage obtained by superimposing an AC voltage on a DC voltage is applied to the developing sleeve 20a.

In the developing device 3a, as shown in FIG. 2, by the first spiral 43, the developer in the first conveyance chamber 22b is stirred and conveyed in the A1 direction (toward the first communication portion 22d) and gradually accumulates at one side of the first conveyance chamber 22b. At the one side of the first conveyance chamber 22b, such an accumulation of the developer is pushed, by a succeeding flow of the developer, upward into the second conveyance chamber 22c via the first communication portion 22d. By the second spiral 44, the developer in the second conveyance chamber 22c is supplied to the developing roller 20, while being stirred and conveyed in the A2 direction (toward the second communication portion 22e). The developer conveyed to the other side of the second conveyance chamber 22c falls into the first conveyance chamber 22b via the second communication portion 22e.

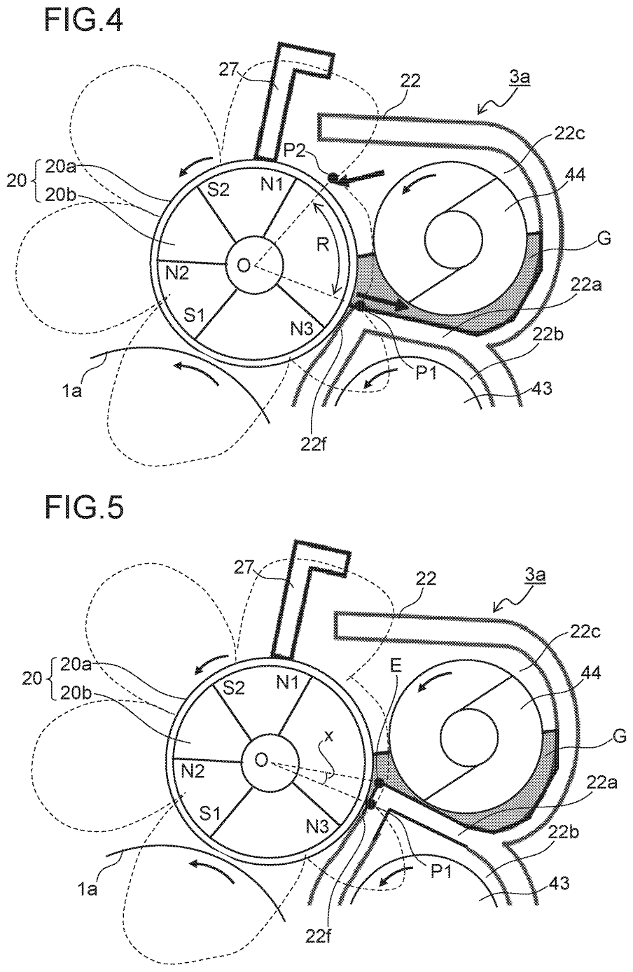

FIG. 3 is a vertical sectional view (a sectional view taken in a direction of arrows X and X′ in FIG. 2) of the developing device 3a of this embodiment cut along a direction orthogonal to a longitudinal direction thereof. FIG. 4 is an enlarged sectional view of and around the second conveyance chamber 22c shown in FIG. 3, illustrating a magnetic force distribution and a developer release region R of the magnetic member 20b of the developing roller 20. The developing device 3a of this embodiment supplies the developer from the second spiral 44 in the second conveyance chamber 22c to the developing roller 20. Further, in this configuration, the developer that has passed through a development region and thus has the toner consumed by development is collected in the second conveyance chamber 22c in which the second spiral 44 is arranged.

As shown in FIG. 3, a regulation blade 27 is mounted to the developing container 22. To be more specific, the regulation blade 27 is mounted along a longitudinal direction of the developing roller 20 (a direction perpendicular to a drawing plane of FIG. 3). A slight gap (regulation gap) is provided between a distal end of the regulation blade 27 and an outer circumferential surface of the developing roller 20, thus constituting a regulation portion. When the developer (magnetic brush) passes through the regulation portion as the developing sleeve 20a rotates, a layer thickness of the developer carried on a surface of the developing roller 20 is regulated. In this embodiment, a magnetic blade made of stainless steel (SUS 430) is used as the regulation blade 27.

The magnetic member 20b of the developing roller 20 includes, along a rotation direction of the developing sleeve 20a (counterclockwise in FIG. 3), a regulation pole (pump-up pole) N1 arranged in a region (the regulation portion) opposed to the regulation blade 27, a main pole S1 arranged in a region (the development region) opposed to the photosensitive drum 1a, and a release pole N3 for releasing the developer carried on the developing roller 20. The magnetic member 20b further includes conveyance poles N2 and S2 arranged between the regulation pole (pump-up pole) N1 and the main pole S1 and thus has five magnetic poles. The regulation pole N1 functions also as a pump-up pole for pumping up the developer onto the developing roller 20 and thus has a magnetic pole width (central angle) greater than those of the other magnetic poles. When a driving force is fed to the developing device 3a, while the developing sleeve 20a rotates, the magnetic member 20b does not rotate.

A magnetic field in an attracting direction is generated between the regulation pole N1 of the magnetic member 20b and the regulation blade 27, and thus a magnetic brush composed of chains of developer particles is formed between the regulation blade 27 and the developing roller 20. As the magnetic brush passes through the regulation blade 27 (regulation portion), a layer thickness of the magnetic brush is regulated to a desired height. After that, when the developing sleeve 20a rotates counterclockwise, by the conveyance poles S2 and N2, a magnetic field in a direction along an outer circumferential surface of the developing sleeve 20a is applied to the magnetic brush, causing the magnetic brush to move to the development region. Further, by the main pole S1, a magnetic field in an attracting direction between itself and the photosensitive drum 1a is applied to the magnetic brush, causing the magnetic brush to contact the surface of the photosensitive drum 1a and develop an electrostatic latent image thereon. Furthermore, residual toner remaining unused for development is collected by the magnetic brush on the developing sleeve 20a.

When the developing sleeve 20a further rotates counterclockwise, under a repelling magnetic field between the release pole N3 and the regulation pole (pump-up pole) N1, the magnetic brush is detached from the developing roller 20 and collected in the second conveyance chamber 22c.

To be more specific, as shown in FIG. 4, a point P1 at which the release pole N3 for releasing the developer on the developing roller 20 after its passage through the development region has a magnetic force of not more than 5 mT (a position between the release pole N3 and the pump-up pole N1 at which a peak magnetic force of the release pole N3 falls) is defined as a release start position. Furthermore, a region of the developing roller 20 in which a magnetic force between the release pole N3 and the pump-up pole N1 is not more than 5 mT is defined as a developer release region R. Moreover, a point P2 at which the pump-up pole N1 for pumping up the developer onto the developing roller 20 after its passage through the developer release region R has a magnetic force of not less than 5 mT (a position between the release pole N3 and the pump-up pole N1 at which a peak magnetic force of the pump-up pole N1 rises) is defined as a pumping-up start position.

That is, at the release start position P1, the developer (magnetic brush) on t developing roller 20 starts to be detached from the developing roller 20 and, after being stirred together with the developer in the second conveyance chamber 22c by the second spiral 44, at the pumping-up start position P2, starts to be pumped up again onto the developing roller 20 under a magnetic force of the regulation pole (pump-up pole) N1 so that a magnetic brush is formed thereon.

In the developing device 3a of this embodiment, the second conveyance chamber 22c is arranged above the first conveyance chamber 22b. That is, the first conveyance chamber 22b and the second conveyance chamber 22c are arranged one above the other. This enables size reduction of the developing device 3a in a horizontal direction. In the image forming apparatus 100, the four developing devices 3a to 3d are arranged in the horizontal direction, and thus size reduction of the developing devices 3a to 3d is particularly effective in achieving size reduction of the image forming apparatus 100. Furthermore, the developing roller 20 is arranged on a lower side relative to the second spiral 44 in the second conveyance chamber 22c. This enables size reduction of the developing device 3a also in a perpendicular direction.

Furthermore, as shown in FIG. 3, where L1 is a horizontal straight line passing through a center of the rotary shaft 44b of the second spiral 44 in the second conveyance chamber 22c and L2 is a horizontal straight line passing through a rotation center of the developing roller 20, L2 is positioned below L1.

Furthermore, the developing container 22 includes a division wall 22f extending downward from below the second spiral 44 (second conveyance chamber 22c) so as to be opposed to the developing roller 20. The division wall 22f is formed to be continuous with a distal end of the partition 22a (an end thereof near the developing roller 20) dividing the first conveyance chamber 22b and the second conveyance chamber 22c from each other. Further, where L3 is a horizontal straight line passing through a center of the rotary shaft 43b of the first spiral 43 in the first conveyance chamber 22b, L3 is positioned below L2.

Thus, the developer that has been separated from the developing roller 20 can be collected in a lower part of the second conveyance chamber 22c filled with the developer. As a result, it is possible to suppress flying-up of the toner inside the developing container 22 and thus to suppress scattering of the toner through a gap between the developing roller 20 and the developing container 22 to outside the developing devices 3a to 3d.

### 3. Relationship Between Endpoint Position of Division Wall and Release Start Position in Developing Device

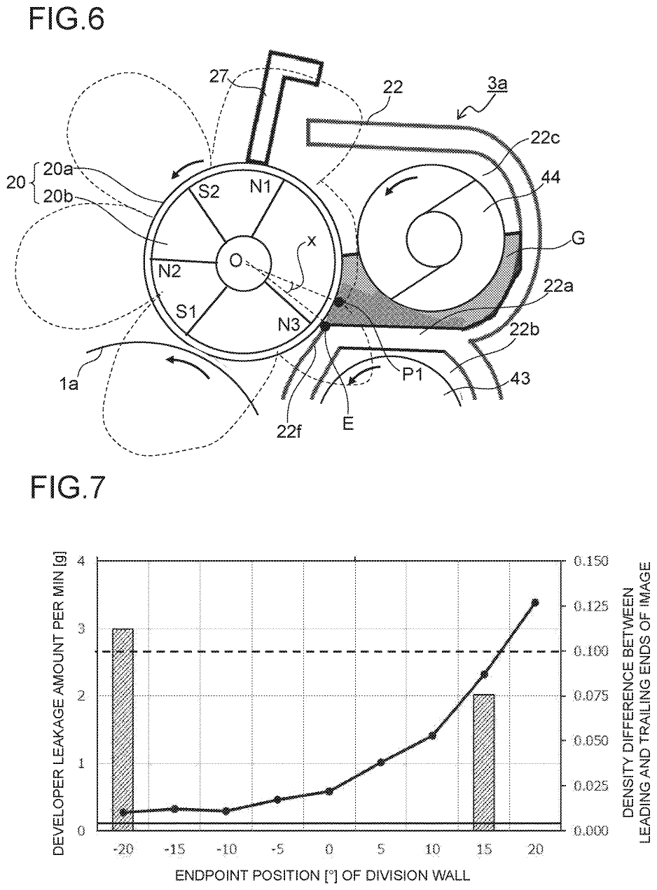

Next, a description is given of a relationship between an endpoint position o the division wall 22f of the developing container 22 and the release start position P1 for releasing the developer. FIGS. 5 and 6 are enlarged sectional views of and around the second conveyance chamber 22c indicative of a relationship between the release start position P1 and an endpoint position E of the division wall 22f, illustrating cases where the endpoint position E lies, respectively, downstream and upstream of the release start position P1 in a rotation direction of the developing roller 20. The endpoint position E of the division wall 22f refers to an end of the division wall 22f near the second conveyance chamber 22c (an upper end of the division wall 22f in FIGS. 5 and 6).

In the case where, as shown in FIG. 5, the endpoint position E of the division wall 22f lies downstream of the release start position P1, when the endpoint position E is too far downstream from the release start position P1, the developer that has been released at the release start position P1 can hardly be collected in the second conveyance chamber 22c and remains trapped between the release start position P1 and the endpoint position E. Further, when such a trapped developer increases in amount to such an extent that it can no longer be held under a magnetic force of the release pole N3, there is a possibility of leakage thereof through a gap between the developing roller 20 and the division wall 22f.

Furthermore, the farther downstream the endpoint position E of the division wall 22f lies, the closer the developer that has been released from the developing roller 20 is to the regulation pole (pump-up pole) N1, and thus the more likely the developer is to be resupplied to the developing roller 20. As a result, there occurs an increase in image density difference between leading and trailing ends of an output image.

On the other hand, in the case where, as shown in FIG. 6, the endpoint position E of the division wall 22f lies upstream of the release start position P1, there is a possibility that the developer cannot be held at the release pole N3 and leaks through the gap between the developing roller 20 and the division wall 22f. That is, there is an appropriate range for an angle X [°] formed between a straight line passing through a rotation center O of the developing roller 20 and the release start position P1 and a straight line passing through the rotation center O of the developing roller 20 and the endpoint position E of the division wall 22f.

To this end, in configurations shown in FIGS. 5 and 6, there was examined a relationship between the endpoint position E of the division wall 22f and leakage and a resupplying property of the developer. A test method was adopted in which, while the endpoint position E of the division wall 22f was made to vary, full-surface solid images (solid images) were outputted, and an image density difference ΔID between leading and trailing ends of each of the images was measured. When improper release of the developer occurs, i.e., the developer is resupplied to a developing roller, at a trailing end of a sheet surface, the developer having the toner consumed is supplied thereto, causing a decrease in image density. A target value of ΔID was set to not more than 0.1, and values of the endpoint position E of the division wall 22f satisfying the target value were determined. Furthermore, in view of possible leakage of the developer occurring as the endpoint position E of the division wall 22f was made to vary, values of the endpoint position E of the division wall 22f at which the leakage of the developer was prevented from occurring were also determined.

As a testing machine, an image forming apparatus 100 (manufactured by KYOCERA Document Solutions Japan Inc.) as shown in FIG. 1 was used, and a sheet conveyance velocity (process linear velocity) was set to 195 mm/sec. Furthermore, a developing roller 20 having an outer diameter of 16 mm was used and set to have a linear velocity ratio to the photosensitive drums 1a to 1d of 1.4 and a rotation velocity of 138 rpm. Furthermore, a gap (regulation gap) between the developing roller 20 and a regulation blade 27 was set to 0.40 mm, and a gap (development gap) between each of the photosensitive drums 1a to 1d and the developing roller 20 was set to 0.34 mm.

Criteria for evaluating the image density difference were set such that a case where the density difference ΔID between leading and trailing ends of an image exceeded 0.100 was regarded as not good. Criteria for evaluating a developer leakage amount were set such that a case where a developer leakage amount per minute was not less than 0.1 g was regarded as not good. FIG. 7 shows results thereof.

FIG. 7 is a graph showing variations in developer leakage amount and in image density difference in a case where the endpoint position E of the division wall 22f is made to vary. In FIG. 7, the image density difference is shown by a line graph, and the developer leakage amount is shown by a bar graph. A horizontal axis in FIG. 7 indicates, in terms of the angle X [°], the endpoint position E of the division wall 22f. To be more specific, along the horizontal axis, it is shown that the angle X has a positive (+) value when the endpoint position E lies downstream of the release start position P1 and has a negative (−) value when the endpoint position E lies upstream of the release start position P1 in the rotation direction of the developing roller 20 (counterclockwise in FIGS. 5 and 6). Furthermore, two vertical axes in FIG. 7 indicate a leakage amount of the developer (a left vertical axis in FIG. 7) and the density difference ΔID between leading and trailing ends of a full-surface solid image (a right vertical axis in FIG. 7).

As shown in FIG. 7, when the angle X has a value higher than −20° in a negative direction (toward upstream), the developer cannot be held at the release pole N3 and might leak from the developing devices 3a to 3d. Furthermore, when the angle X has a value higher than +15° in a positive direction (toward downstream), the developer that has been released at the release start position P1, without being conveyed to the second conveyance chamber 22c, remains trapped between the release start position P1 and the endpoint position E, and when such a trapped developer increases to such an extent that it can no longer be held under a magnetic force of the release pole N3, leakage thereof might occur.

Furthermore, the farther downstream the endpoint position E of the division wall 22f is from the release start position P1, the closer the developer that has been released from the developing roller 20 is to the regulation pole (pump-up pole) N1, and thus the more likely the developer is to be resupplied to the developing roller 20, so that there occurs an increase in the density difference ΔID between leading and trailing ends of an image. When the angle X has a value higher than +15° in the positive direction (toward downstream), the density difference ΔID might become higher than the target value (=0.100). Based on results described above, the endpoint position E of the division wall 22f is designed so that the angle X [°] satisfies a formula (1) below.

−15≤X≤10 (1)

Thus, it is possible to suppress a phenomenon in which the developer that h once been released from the developing roller 20 is resupplied to the developing roller 20 and also to suppress leakage of the developer from the developing devices 3a to 3d. That is, it is possible to achieve both good releasability of the developer from the developing roller 20 and prevention of leakage of the developer from the developing devices 3a to 3d.

Furthermore, in this embodiment, the second spiral 44 directly opposed to the developing roller 20 is provided at a position higher than that of the developing roller 20. That is, the horizontal straight line L2 passing through the rotation center of the developing roller 20 is positioned below the straight line L1 passing through a rotation center of the second spiral 44. This configuration makes it likely that the developer that has passed through the endpoint position E of the division wall 22f accumulates in a vicinity of the release start position P1, thus making it likely that the above-described effect of releasing the developer is exerted.

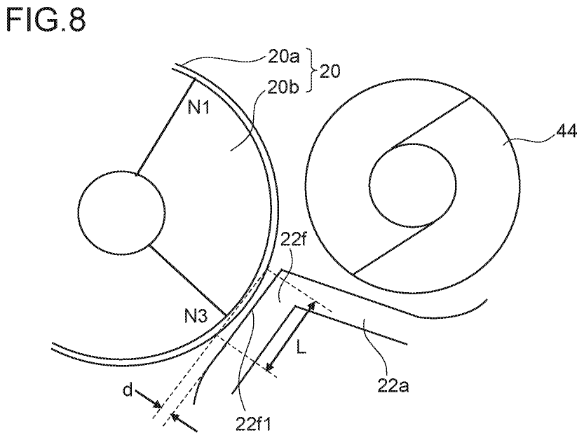

FIG. 8 is a partially enlarged view of and around the division wall 22f shown in FIG. 4. As shown in FIG. 8, the division wall 22f includes an opposed portion 22f1 opposed at a prescribed distance d or less to the outer circumferential surface of the developing roller 20. When the opposed portion 22f1 is short in length in a top-bottom direction, it becomes likely that the developer leaks through the gap between the developing roller 20 and the division wall 22f. In the configuration of the present disclosure, the endpoint position E of the division wall 22f is designed so that the angle X [°] satisfies the formula (1), and thus particularly in a developing device in which the opposed portion 22f1 is opposed at the distance d of not more than 3 mm to the outer circumferential surface of the developing roller 20 and has a length L of not more than 5 mm in the top-bottom direction, this configuration makes it likely that the effect of suppressing leakage of the developer is exerted and thus can be used favorably.

In addition, the present disclosure is not limited to the foregoing embodiment and can be variously modified without departing from the spirit of the present disclosure. For example, while the foregoing embodiment has shown an example in which the developer is supplied from the second spiral 44 to the developing roller 20, the present disclosure is not limited thereto. For example, a configuration may be adopted in which a magnetic roller (developer carrying member) is provided adjacently to the second spiral 44, and after a developer is supplied from the second spiral 44 to the magnetic roller, toner is supplied from the magnetic roller to a developing roller (toner supplying member).

Furthermore, while the foregoing embodiment has described the developing devices 3a to 3d of a vertical conveyance type each including the first conveyance chamber 22b and the second conveyance chamber 22c arranged above the first conveyance chamber 22b, the present disclosure is also applicable similarly to a developing device of a horizontal conveyance type in which a first conveyance chamber and a second conveyance chamber are arranged side by side.

Furthermore, while the foregoing embodiment has a configuration in which t regulation pole N1 has an increased magnetic pole width so that it can be used also as a pump-up pole, the pump-up pole may be separately provided upstream of the regulation pole N1 in the rotation direction of the developing roller 20. Moreover, while the foregoing embodiment includes the two conveyance poles N2 and S2, one or three or more conveyance poles may be arranged.

Furthermore, the present disclosure is not limited to a direct transfer type color printer as shown in FIG. 1 and is applicable also to various types of image forming apparatuses each provided with a developing device including a first conveyance chamber and a second conveyance chamber arranged above the first conveyance chamber, such as an intermediate transfer type color printer including an intermediate transfer belt and a secondary transfer roller instead of a conveyance belt 8, a digital or analog monochrome copy machine, a digital or analog color copy machine, and a facsimile.

The present disclosure is usable in a developing device including a first conveyance chamber and a second conveyance chamber arranged adjacently to the first conveyance chamber. Through the use of the present disclosure, it is possible to provide a developing device capable of suppressing, even in a configuration in which a developer is always present at a release position, leakage of the developer and the phenomenon in which the developer that has once been released is resupplied, and an image forming apparatus provided with the same.

What is claimed is:

1. A developing device, comprising:
a developing container including:
a first conveyance chamber; and
a second conveyance chamber arranged adjacently to the first conveyance chamber via a partition,
the developing container containing a developer including a carrier and toner;
a first stirring conveyance member that is rotatably supported in the first conveyance chamber and conveys, while stirring, the developer in the first conveyance chamber in a first direction;
a second stirring conveyance member that is rotatably supported in the second conveyance chamber so as to be parallel to the first stirring conveyance member and conveys, while stirring, the developer in the second conveyance chamber in a second direction opposite to the first direction;
a developer carrying member that is rotatably supported to the developing container and carries, on a surface thereof, the developer in the second conveyance chamber; and
a regulation blade that is arranged to be opposed to the developer carrying member and regulates a layer thickness of the developer on the developer carrying member,
the developing device being configured to develop an electrostatic latent image formed on an image carrier into a toner image,
wherein
the developing device performs, in the second conveyance chamber, supply of the developer to and collection of the developer from the developer carrying member,
the developer carrying member includes:
a rotatable cylindrical developing sleeve; and
a magnetic member non-rotatably secured inside the developing sleeve and having, along a rotation direction of the developing sleeve, a plurality of magnetic poles including a regulation pole opposed to the regulation blade, a main pole opposed to the image carrier, a release pole for releasing the developer carried on the developer carrying member, and a pump-up pole for pumping up the developer onto the developer carrying member,
the developing container includes a division wall extending downward from below the second conveyance chamber so as to be opposed to the developer carrying member, and
where X [°] is an angle formed between a straight line passing through a rotation center of the developer carrying member and a release start position at which the release pole has a magnetic force of not more than 5 [mT] and a straight line passing through the rotation center of the developer carrying member and an endpoint position of the division wall at an end thereof near the second conveyance chamber, and X has a positive value when the endpoint position lies downstream of the release start position in the rotation direction of the developing sleeve and has a negative value when the endpoint position lies upstream thereof, a formula (1) below is satisfied:
−15≤X≤10 (1).

2. The developing device according to claim 1, wherein
the second conveyance chamber is arranged above the first conveyance chamber via the partition, and
where L1 is a horizontal straight line passing through a center of a rotary sh of the second stirring conveyance member in the second conveyance chamber and L2 is a horizontal straight line passing through a center of a rotary shaft of the developer carrying member, the straight line L1 is positioned above the straight line L2.

3. The developing device according to claim 1, wherein
the division wall includes an opposed portion opposed at a distance of not more than 3 mm to an outer circumferential surface of the developer carrying member, and
the opposed portion has a length of not more than 5 mm in a top-bottom direction.

4. The developing device according to claim 2, wherein
the division wall is formed to be continuous with an end of the partition near the developer carrying member, the partition dividing the first conveyance chamber and the second conveyance chamber from each other in a top-bottom direction, and
where L3 is a horizontal straight line passing through a center of a rotary sh of the first stirring conveyance member in the first conveyance chamber, the straight line L3 is positioned below the straight line L2.

5. An image forming apparatus comprising the developing device according to claim 1.
